(19) United States
(12) Patent Application Publication
(10) Pub. No.: US 2005/0277097 A1
(43) Pub. Date: Dec. 15, 2005

(54) Taxidermy-related products

(76) Inventors: Michael A. Galligan, Oshkosh, WI (US); Floyd A. Banks, Appleton, WI (US)

Correspondence Address: WILHELM LAW SERVICE, S.C., 100 W LAWRENCE ST, THIRD FLOOR, APPLETON, WI, 54911, US

(21) Appl. No.: 10/868,473

(22) Filed: Jun. 15, 2004

(51) Int. Cl. G09B 23/00

(52) U.S. Cl. 434/295

(57) ABSTRACT

Taxidermy-related products individually incorporate representations of body parts from two or more species. The merge or joining of the body parts can be so configured that the appearance of the product adjacent the merger or joint suggests continuity of thought and/or expression between the first and second body parts. The joint or merger can be entirely imaginary in the finished product e.g. when the product is mass-produced of entirely man-made materials, such as plastics, plastic foams, and respective sheet materials and/or coatings. Products of the invention can be mass-produced using natural animal parts where such parts are available in suitable quantities. Some or none of the materials used in the product can be materials which are taken from, or are, naturally-occurring body parts of respective ones of the animals. One of the first and second species can be a natural predator of the other.

### BACKGROUND

Taxidermy, as a craft, incorporates a wide variety of skills, including carpentry, wood working, tanning, molding and casting, and artistic talent including the arts of sculpture, painting and drawing, in making what is commonly referred to as a “mount” of an animal. In making a deer head mount, for example, the only natural parts of the animal which are used are the antlers and the skin. All other organs and tissues are represented by man-made, e.g. synthetic, materials, for example glass eyes, clay eyelids, and wax or epoxy about the nose and mouth. The manikin, or internal form, is typically foam, for example polyurethane foam.

When fish skin dries, the color fades from the skin, leaving only brownish patterns on the skin and scales. Accordingly, the taxidermist recreates the original colors of the skin over the entirety of the fish or fish representation in developing the mounted fish product.

Warm water fish, such as bass, crappie, and bream generally have relatively tougher skins and relatively larger scales, and are good candidates for skin mounts, wherein the skin is either mounted over a manikin, or the fish's body cavity is packed with a filler material which is shaped and then allowed to harden.

Such warm water fish typically can be mounted with the natural skull still attached to the natural skin. The natural fins and tail are also typically preserved and used in the mount. Thus, other than colorants and other coatings, mounts of warm water fish can use natural fish materials for the entire outer surface of the mount, including the head and the skull.

Cold water fish such as trout, salmon, and char, on the other hand, have relatively thinner, and smoother, skins, and have relatively finer scales. Natural skulls or artificial heads can be used, and are typically attached to a natural skin-mounted body. Thus, mounts of cold water fish use natural fish materials for the skin, the fins, and the tail, while the head can be either natural or artificial.

Taxidermy mounts of saltwater fish, as well as some cold water fish, are commonly created entirely from man-made materials. While the fish is fresh, a carefully constructed mold of the fish is made. Then, the body and fins of the fish are cast in polyester. The unadorned polyester mold of the fish is called a blank because it has no fish markings or natural fish coloration. The taxidermist then creates, through artistic rendering, the appropriate fish coloration or coloration pattern on the blank to make the thus-decorated blank appear like a live fish of the respective species.

Since one specific fish of a given species and length is shaped more or less the same as any other specific fish of the given species and length, taxidermists typically purchase molded fish blanks, and paint or otherwise decorate the blank to provide the desired natural coloration or coloration pattern. As desired, the taxidermist can purchase a blank of only the body, and join the natural head, or a portion of the head, or an artificial head, to the blank.

In general, the taxidermist creates a representation, or preservation, of a specific animal of a given species, commonly an animal which has been captured by hunting or fishing, or other hunter/gatherer activities. On the other hand, to some extent, the work of the taxidermist is to make and preserve a representation of the species, which representation may or may not represent a specific animal.

Thus, the craft of taxidermy seeks to provide a product which is a re-creation, or representation, of an animal, or a species of animals, which conjures up, in the mind of a viewer of the product, an image or recollection of the living animal. In making such products, the taxidermist typically uses whatever materials he/she can, if any, from the specimen animal, and substitutes other materials accordingly.

Considering that, in some cases, no parts of the specimen animal are used, the boundary between (i) the craft of taxidermy and its products, and (ii) mass-produced look-alike products, is not well defined. Thus, as used herein, the phrase “taxidermy product” refers to all such products which are not mass-produced; and the phrase “taxidermy-related product” further includes such mass-produced products so long as all the other conditions, attached herein to such product, are met.

The value of taxidermy products is generally that of a recreational product, whether as sports memorabilia, as a memory re-creation, as pure entertainment, or as a piece of art.

Regarding use as a piece of art, as memory re-creation, or as pure entertainment, the use of taxidermy products has been, in general, limited to displaying accurate representations of individual specimens of animals of a given species. In some cases, the representations do use certain naturally-occurring parts of the animal being represented. In other cases, the representations are entirely man-made representations, and have, on some occasions, included mass-produced products, and mass-marketed products, marketed generally as toys or entertainment. In any event, the market for such products is limited by the market for the individual species being represented.

It would be desirable to provide additional taxidermy-related product offerings thereby to expand the market for such products.

It would be further desirable to provide additional taxidermy-related product offerings wherein the products combine body parts, or representations of body parts, from first and second species, optionally from specific animals of the respective species, in a taxidermy product, and wherein the product adjacent a joint between the body parts appears to be a generally taxonomically accurate, or scaled, extension, optionally including coloring and/or coloration pattern, of at least one of the respective body parts.

It would be further desirable to provide three-dimensional representations of body parts of first and second species wherein the body parts are merged into a single product, and wherein the merging of the body parts appears to be a generally taxonomically accurate, or scaled, extension, optionally including coloring and/or coloration pattern, of at least one of the respective body parts.

It would be still further desirable to provide three-dimensional representations of body parts of first and second species, wherein the body parts are merged into a single product, and wherein one of the first and second species is a natural predator of the other of the first and second species.

### SUMMARY

The invention relates generally to taxidermy-related products which expand the traditional product line which has been generally acknowledged as being related to the taxidermy trade, to include products which incorporate at least first and second body parts from two or more species of animals. The merging or joining of the respective body parts can be so configured that the appearance of the product adjacent the merger or joint, by e.g. size, configuration, and/or coloration, suggests continuity of thought and/or expression between the body parts of the first and second species.

The joint or merger can be entirely imaginary, such as when the taxidermy-related product is mass-produced of entirely man-made materials, such as molded plastics, plastic foams, and the like.

Some or none of the materials used in the product are materials which are taken from naturally-occurring body parts of respective ones of the animals.

Products of the invention can be mass produced using natural animal parts where the natural animal parts are available in the sufficient quantities.

One of the first and second species can be a predator of the other of the first and second species, and the product can be mass-produced, or not mass-produced.

In a first family of embodiments, the invention comprehends a taxidermy product, comprising a generally taxonomically accurate first core body part representative of a first species of animals, optionally a specific animal, and a generally taxonomically accurate second body part representative of a second species of animals different from the first species, optionally a specific animal. The first core body part comprises first interface structure having a first outer surface which is generally taxonomically accurate. The first core body part is optionally scaled. The first outer surface has a taxonomically accurate or scaled interface outline configuration representative of the first species. The second body part comprises second interface structure having a second outer surface which is generally taxonomically accurate, optionally scaled, with respect to the second species. The second outer surface has a second taxonomically accurate or scaled interface outline configuration representative of the second species. The first and second outline configurations of the first and second body parts have generally common and cooperative dimensions, at the respective first and second interface structures when the first and second interface structures are in their generally taxonomically accurate, optionally scaled, configurations. The first and second body parts are joined to each other at a joint joining the first and second interface structures so as to present a completed taxidermy product wherein a general shape of the first body part at the first outer surface extends generally continuously across the joint and onto the second body part such that at least an initial portion of the second outer surface of the second body part adjacent the joint appears to be a generally taxonomically accurate, or scaled, extension of the outer surface of the first body part.

In some embodiments, the first core body part, in the first species, includes an abdominal cavity.

In some embodiments, the second body part, in the second species, includes a head.

In some embodiments, the first species is an aquatic animal, selected from the group consisting of fish and amphibians, including alligators.

In some embodiments, the second species is an aquatic animal, selected from the group consisting of fish and amphibians, including alligators.

In some embodiments, the first species is a fish and the second species is an amphibian.

In some embodiments, the first species is a fish and the second species is an alligator.

In other embodiments, the first species is an alligator and the second species is a fish.

In some embodiments, one of the first and second species is a natural predator of the other of the first and second species.

In some embodiments, taxonomically accurate color representations of the first and second species are generally complementary of each other such that coloration patterns of the first and second body parts are generally consistent with, and/or complementary of, each other.

In some embodiments, the first and second body parts are merged with each other so as to present a unitary product.

In a second family of embodiments, the invention comprehends, as an article of manufacture, a taxidermy-related product comprising in three-dimensional representation, a generally taxonomically accurate, optionally scaled, first core body part of a first species of animals, and in three-dimensional representation, a generally taxonomically accurate, optionally scaled, second body part of a second species of animals, different from the first species The representation of the first core body part comprises a first interface locus having a first outer surface. The first outer surface has a first taxonomically accurate, optionally scaled, interface outline configuration representative of the first species. The representation of the second body part comprises a second interface locus having a second outer surface. The second outer surface has a second taxonomically accurate, optionally scaled, interface outline configuration representative of the second species. The first and second outline configurations of the first and second body parts have generally common and cooperative first and second outer surfaces at the respective first and second interface loci. The first and second body parts are merged with each other at the respective first and second interface loci, so as to present a unitary product wherein a general shape of the first body part representation at the first outer surface extends generally continuously across the first and second interface loci and onto the second body part representation. At least an initial portion of the second outer surface of the second body part representation, adjacent the second interface locus, appears to be a generally taxonomically accurate, or scaled, extension of the outer surface of the first body part representation.

In some embodiments, at least one of the first and second body parts is comprised entirely of materials foreign to naturally-occurring members of the respective species.

In some embodiments, the product comprises a visual appearance surface comprised of one or more layers, continuous portions of the one or more layers being comprised predominantly of synthetic plastics.

In a third family of embodiments, the invention comprehends, as an article of manufacture, a taxidermy-related product comprising in three-dimensional representation, a generally taxonomically accurate, optionally scaled, first core body part of a first species of animals, and in three-dimensional representation, a generally taxonomically accurate, optionally scaled, second body part of a second species of animals, different from the first species. The representation of the first core body part comprises a first interface locus. The representation of the second body part comprises a second interface locus. The first and second body parts are merged with each other so as to present a unitary product. One of the first and second species is a natural predator of the other of the first and second species.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 shows a side elevation view of a taxidermy product of the invention, including a base supporting the product.

FIG. 2 shows a side elevation view of the product of FIG. 1, without base, with the head, and the core body part, separated to illustrate the location of the joint.

FIG. 3 is a color photographic rendering of the product of FIG. 1, illustrating the continuity of the colors and coloration pattern adjacent and across the joint.

The invention is not limited in its application to the details of construction or the arrangement of the components set forth in the following description or illustrated in the drawings. The invention is capable of other embodiments or of being practiced or carried out in other various ways. Also, it is to be understood that the terminology and phraseology employed herein is for purpose of description and illustration and should not be regarded as limiting. Like reference numerals are used to indicate like components.

### DESCRIPTION OF THE ILLUSTRATED EMBODIMENTS

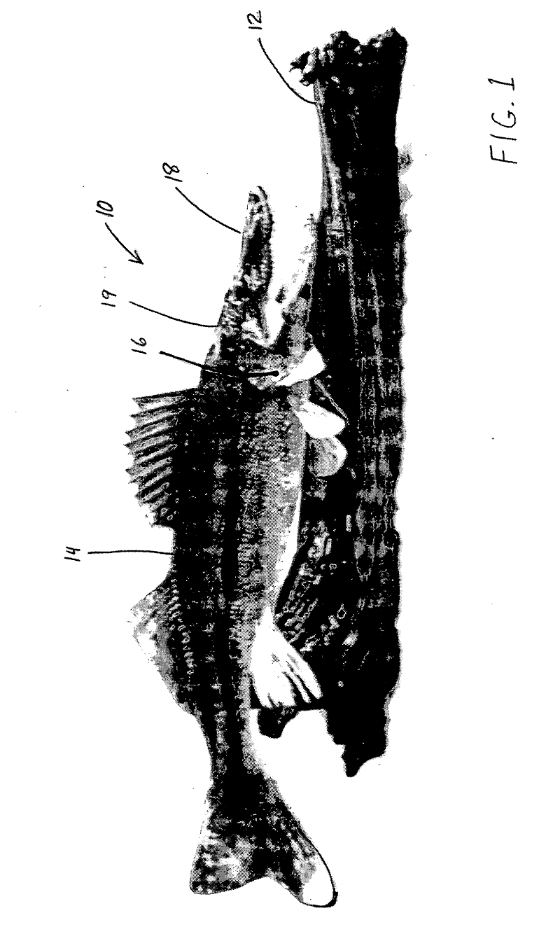

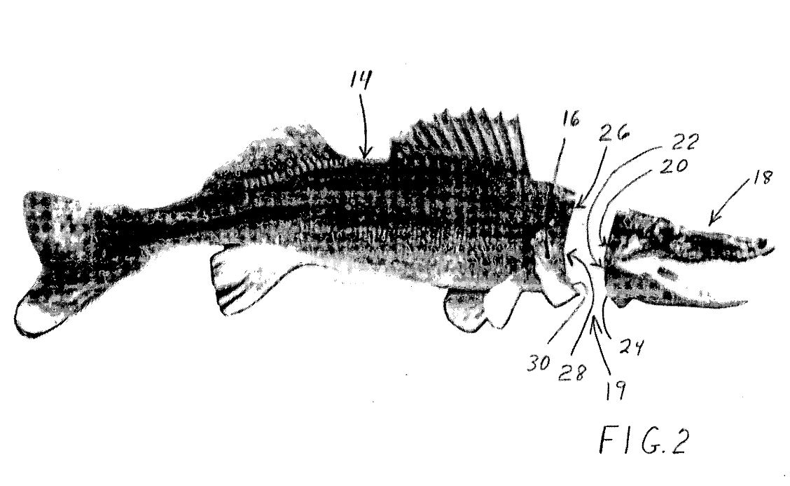

FIG. 1 represents a typical taxidermy product 10 of the invention mounted on a base 12. As illustrated, product 10 includes, as a first core body part 14, the rear portion of the body of a fish, a first species, up to and including the fish gills 16, and as a second body part 18, the head of an alligator, a second species. As illustrated in FIG. 2, the first 14 and second 18 body parts are joined together at a generally vertically-oriented joint 19 in a single taxonomic representation 10 which is part fish and part alligator, and wherein the respective parts of the resultant product are generally taxonomically accurate representations, optionally scaled to size, of the respective body parts in living specimens of the species which are so represented. Joint 19 is invisible in FIG. 1. The location of joint 19 is indicated in the separated view of FIG. 2.

As depicted in FIG. 1, the main body of the product 10 represents the body of a walleye pike fish, from a location approximately at the front of the gills 16, to and through the tail. The second body part represents the head of an alligator of suitable size and shape to mate up with a corresponding-size fish body.

Referring to FIG. 2, interface structure 20 at the rear of the alligator head has a rearwardly-projected interface outline 22 which defines an outer surface 24 at the head interface outline 22. The corresponding interface structure 26 at the front of the fish body, e.g. in front of the gills, has a forwardly-projected interface outline 28 which defines an outer surface 30 at the body interface outline 28.

Interface structures 20, 26 are so designed and configured, or selected and configured, that when brought together, the outer surfaces 24, 30, e.g. at the front of core body part 14 and at the rear of head body part 18, are, in taxonomically accurate, or scaled, representations of the respective body parts, susceptible of being joined or merged with each other such that the joinder or merger line can be artistically finished whereby the appearance adjacent the joint or merger can be that of a taxonomically accurate, or scaled, extension of the outer surface of at least one of the body parts 14, 18, preferably both body parts. Namely, the outline configurations 22, 28 of body parts 14, 18, have generally common and cooperative dimensions facing each other when the interface structures are in their generally taxonomically accurate configurations, optionally scaled, such that the outline configurations 22, 28 extend in generally overlapping relationship from one to the other in joining body parts 14, 18 at joint 19.

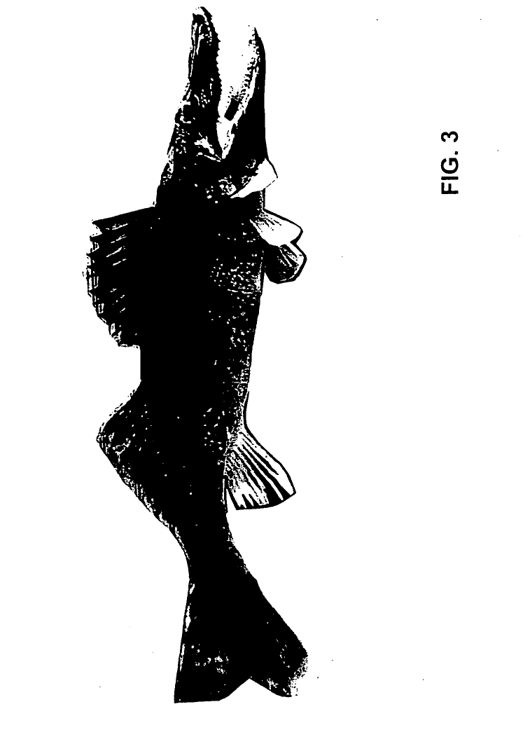

Referring to the embodiments illustrated in FIGS. 1 and 3, the body of the fish, adjacent joint 19, appears, in size, configuration, and color or coloration pattern, to be an extension of the head of the alligator. Similarly, the head of the alligator appears, in size, configuration, and color or coloration pattern, to be an extension of the body of the fish.

The fish body shown includes all parts of the fish except for the head of the fish. Thus, the main generally torpedo-like shape of a typical walleye has been preserved and expressed in the fish body. As seen in FIG. 3, the color and/or coloration pattern of the product, on the fish body portion of the product, is a faithful reproduction of the typical coloration of the species of fish being represented, e.g. walleye pike. In the embodiments illustrated in the drawings, all fins, and the tail, have been preserved, and presented, in their naturally-occurring locations, with naturally-occurring sizes, configurations, colorations, and the like, such that the main body of the product is generally representative of the species of fish being represented in the product.

In general, the invention contemplates a core body part 14 which typically, but not necessarily, includes some or all of the portion of the body which houses the major organs, sometimes referred to as the abdominal cavity. However, in the invention, the core body part fails to present a complete image of the species of animal being represented in that the core body part is devoid of a major body part, e.g. a head, which is generally associated with the species being represented. Further to the invention, the core body part terminates at fabricated interface structure 26 which represents e.g. a cut line where the head of the species would have otherwise been joined to the core body part. In the embodiments shown, the cut line, also expressed as joint 19, represents more-or-less the normal dividing line between the body of the fish and the head of the fish, whereby the first and second body parts are well described as “core body part ”and “head”.

Methods of fabricating joints between various materials in taxidermy products are known to those skilled in the art, whereby once the concept has been disclosed, of using first and second body parts from respective first and second species of animals, methods of fabricating joint 19 need not be discussed in detail. There can be mentioned, as examples, adhesive joining of sheet-like materials over a blank core, or laminating various sheet-like layers such as over a blank core. Other methods are well known to those skilled in the art.

While only a body/head combination is shown in the drawings, a substantial variety of other combinations are contemplated. However, in all cases, the direction of extension of the outer surface of both mated body parts is expressed both leading up to, and at, joint 19 or other rendering of the coming together of the first and second body parts.

As another expression of the invention, the tail portion of the fish can be replaced with e.g. an alligator tail, or tail from another species so long as the outline of both the fish body and the tail of the second species are consistent with being extensions of each other adjacent the corresponding joint. In such embodiments, the product can employ the head of the fish, the head of another species of fish, the head of an alligator, or the head of some other species of animal.

Another expression of the scope of the invention looks to a wide variety of species which can be expressed in terms of the recited first and second species.

There can be mentioned, for example, a wide variety of fishes, both for the core body part and for the second body part.

Similarly, the first and second species can both be different species of fish. Similarly, either or both species can be amphibians. There can be mentioned, for example, alligators, crocodiles, frogs, snakes, salamanders, and like.

In addition, the species can be selected from land-dwelling animals, or one land-dwelling animal and one water-dwelling or amphibious animal.

Taxidermy-related products of the invention can be made from a wide variety of materials. Of course, the naturally-occurring body parts of the species being represented are always possible materials which can be considered for use in the product. However, a wide range of other materials are well known for use in taxidermy products, either where the corresponding naturally-occurring body component has a limited use life, or is otherwise not known for long-term stability or durability of materials. In addition, non-species related materials can be used in place of naturally occurring species related materials for a variety of other reasons, including cost, availability, quality and aesthetic appeal of end product, and the like. Accordingly, it is known to use glass, clay, various polymeric materials, and the like as components of the product.

In some instances, it is known to make mass-produced taxidermy-related products entirely of materials which are foreign to naturally-occurring members of the represented species. Such materials can be non-naturally-occurring materials, such as various of the polymers, namely synthetic plastics such as polyolefins, vinyl chloride copolymers, and the like.

Whether the product is mass-produced, or a hand-crafted item using traditional taxidermy methods, product can be decorated using any of a variety of methods and materials. For example, a body core or manikin can be overlaid with a naturally-occurring skin. In the alternative, the body can be overlaid with a material, typically a sheet material, which is non-naturally occurring in the species, and which may be a sheet material which does not naturally occur in any known animal. Further, such sheet materials can be applied in multiple layers. The sheet material itself can be colorless, colored as desired with a uniform color, or can be pre-printed with a desired color pattern.

Where the product includes a joint 19, the joint can be overlain by one or more layers of sheet material, thus to effectively camouflage the joint.

In addition to sheet materials, various coatings such as paints can be applied, such as to provide a color, or color pattern to the product. In addition, e.g. clear coatings such as lacquers, varnishes, and others, can be applied to protect the finished product from decay or other affects of being exposed to the ambient environment.

A variety of suitable sheet materials and coatings are known for use in making taxidermy products, whereby no further discussion of such materials is required herein.

Mass-produced products of the invention can be animated by e.g. battery-powered devices which can cause the animal to flex in e.g. a simulation of certain movements which are commonly known or contemplated in one or more of the species being represented by the resulting product. It will be understood that the exterior of a given such mass-produced product can be fabricated as a single unit whereby the indication herein of first and second body parts is illustrative only to the extent of indicating representations of parts of first and second different species, and does not necessarily indicate the actual existence at any point in time of two separate elements of the product. For example, the entirety of the body of the finished product, e.g. first core body part and second body part, can be molded all at once, in a single mold, or can be assembled by joining together various edges or other elements of a single work piece.

In all embodiments herein, the invention contemplates at least first and second different species of animals. The invention also contemplates that the outline configurations of the outer surfaces of the respective body parts are generally consistent, such as in height and width, so as to be readily joined with each other at consistent directions of extension. For example, where the outer surface of the interface outline of the fish body represents a generally flat fish, then the outer surface of the interface outline of any head selected for joinder with that flat fish body necessarily has to have generally the same taxonomically flat configuration.

Similarly, where the outer surface of the interface outline of the fish body represents a more rounded cross-section, as in the illustrated embodiments, the outer surface of the interface outline of any head selected for joinder with a respective such fish body necessarily has to have generally the same taxonomically rounded configuration as the interface outline on the fish body.

Where the interface outline of the outer surface is compatible, and the only difference is one of scale, the invention contemplates using a replica of one of the selected body parts, e.g. head, either enlarged or reduced in size from the naturally-occurring size, so long as the resulting scaled replica is faithful to the naturally-occurring relative dimensions of the naturally-occurring body part.

Those skilled in the art will now see that certain modifications can be made to the apparatus and methods herein disclosed with respect to the illustrated embodiments, without departing from the spirit of the instant invention. And while the invention has been described above with respect to the preferred embodiments, it will be understood that the invention is adapted to numerous rearrangements, modifications, and alterations, and all such arrangements, modifications, and alterations are intended to be within the scope of the appended claims.

To the extent the following claims use means plus function language, it is not meant to include there, or in the instant specification, anything not structurally equivalent to what is shown in the embodiments disclosed in the specification.

1. A taxidermy product, comprising:
(a) a generally taxonomically accurate first core body part representative of a specific animal of a first species of animals, said first core body part comprising first interface structure having a first outer surface which is generally taxonomically accurate, optionally scaled, the first outer surface having a taxonomically accurate or scaled interface outline configuration representative of the first species; and
(b) a generally taxonomically accurate second body part representative of a specific animal of a second species of animals, different from the first species, said second body part comprising second interface structure having a second outer surface which is generally taxonomically accurate, optionally scaled, with respect to the second species, the second outer surface having a second taxonomically accurate or scaled interface outline configuration representative of the second species,
the first and second outline configurations of the first and second body parts having generally common and cooperative dimensions, at the respective first and second interface structures when the first and second interface structures are in their generally taxonomically accurate, optionally scaled, configurations, the first and second body parts being joined to each other at a joint joining said first and second interface structures so as to present a completed taxidermy product wherein a general shape of said first body part at the first outer surface extends generally continuously across the joint and onto said second body part such that at least an initial portion of the second outer surface of said second body part adjacent the joint appears to be a generally taxonomically accurate, or scaled, extension of the outer surface of said first body part.

2. A taxidermy product as in claim 1 wherein said first core body part, in the first species, includes an abdominal cavity.

3. A taxidermy product as in claim 2 wherein said second body part, in the second species, includes a head.

4. A taxidermy product as in claim 2 wherein said first species is an aquatic animal, selected from the group consisting of fish and amphibians, including alligators.

5. A taxidermy product as in claim 1 wherein said second species is an aquatic animal, selected from the group consisting of fish and amphibians, including alligators.

6. A taxidermy product as in claim 1 wherein said first species is a fish and said second species is an amphibian.

7. A taxidermy product as in claim 1 wherein said first species is a fish and said second species is an alligator.

8. A taxidermy product as in claim 1 wherein said first species is an alligator and said second species is a fish.

9. A taxidermy product as in claim 1 wherein one of said first and second species is a natural predator of the other of said first and second species.

10. A taxidermy product as in claim 1 wherein taxonomically accurate color representations of the first and second species are generally complementary of each other such that coloration patterns of said first and second body parts are generally consistent with, and/or complementary of, each other.

11. A taxidermy product as in claim 9, the first and second body parts being merged with each other so as to present a unitary product.

12. A taxidermy product, comprising:
(a) a generally taxonomically accurate first core body part representative of a first species of animals, said first core body part comprising first interface structure having a first outer surface which is generally taxonomically accurate, optionally scaled, the first outer surface having a taxonomically accurate or scaled interface outline configuration representative of the first species; and
(b) a generally taxonomically accurate second body part representative of a second species of animals, different from the first species, said second body part comprising second interface structure having a second outer surface which is generally taxonomically accurate, or scaled, with respect to the second species, the second outer surface having a second taxonomically accurate, optionally scaled, interface outline configuration representative of the second species,
the first and second outline configurations of the first and second body parts having generally common and cooperative dimensions, at the respective first and second interface structures when the first and second interface structures are in their generally taxonomically accurate, optionally scaled, configurations, the first and second body parts being joined to each other at a joint joining said first and second interface structures so as to present a completed taxidermy product wherein a general shape of said first body part at the first outer surface extends generally continuously across the joint and onto said second body part such that at least an initial portion of the second outer surface of said second body part adjacent the joint appears to be a generally taxonomically accurate, or scaled, extension of the outer surface of said first body part.

13. A taxidermy product as in claim 12 wherein said first core body part, in the first species, includes an abdominal cavity.

14. A taxidermy product as in claim 13 wherein said second body part, in the second species, includes a head.

15. A taxidermy product as in claim 13 wherein said first species is an aquatic animal, selected from the group consisting of fish and amphibians, including alligators.

16. A taxidermy product as in claim 12 wherein said second species is an aquatic animal, selected from the group consisting of fish and amphibians, including alligators.

17. A taxidermy product as in claim 12 wherein said first species is a fish and said second species is an amphibian.

18. A taxidermy product as in claim 12 wherein said first species is an alligator and said second species is a fish.

19. A taxidermy product as in claim 12 wherein one of said first and second species is a natural predator of the other of said first and second species.

20. A taxidermy product as in claim 12 wherein taxonomically accurate color representations of the first and second species are generally complementary of each other such that coloration patterns of said first and second body parts are generally consistent with, and/or complementary of, each other.

21. A taxidermy product as in claim 19, the first and second body parts being merged with each other so as to present a unitary product.

22. As an article of manufacture, a taxidermy-related product comprising:
(a) in three-dimensional representation, a generally taxonomically accurate, optionally scaled, first core body part of a first species of animals, said representation of said first core body part comprising a first interface locus having a first outer surface, the first outer surface having a first taxonomically accurate, optionally scaled, interface outline configuration representative of the first species; and
(b) in three-dimensional representation, a generally taxonomically accurate, optionally scaled, second body part of a second species of animals, different from the first species, said representation of said second body part comprising a second interface locus having a second outer surface, the second outer surface having a second taxonomically accurate, optionally scaled, interface outline configuration representative of the second species,
the first and second outline configurations of the first and second body parts having generally common and cooperative first and second outer surfaces at the respective first and second interface loci, and the first and second body parts being merged with each other at the respective first and second interface loci, so as to present a unitary product wherein a general shape of said first body part representation at the first outer surface extends generally continuously across the first and second interface loci and onto said second body part representation such that at least an initial portion of the second outer surface of said second body part representation, adjacent the second interface locus, appears to be a generally taxonomically accurate, or scaled, extension of the outer surface of said first body part representation.

23. A taxidermy-related product as in claim 22 wherein the represented first core body part, in the first species, includes an abdominal cavity.

24. A taxidermy-related product as in claim 23 wherein the represented second body part, in the second species, includes a head.

25. A taxidermy-related product as in claim 22 wherein said first species is an aquatic animal, selected from the group consisting of fish and amphibians, including alligators.

26. A taxidermy-related product as in claim 22 wherein said second species is an aquatic animal, selected from the group consisting of fish and amphibians, including alligators.

27. A taxidermy-related product as in claim 22 wherein said first species is a fish and said second species is an amphibian.

28. A taxidermy-related product as in claim 22 wherein said first species is a fish and said second species is an alligator.

29. A taxidermy-related product as in claim 22 wherein said first species is an alligator and said second species is a fish.

30. A taxidermy-related product as in claim 22 wherein one of said first and second species is a natural predator of the other of said first and second species.

31. A taxidermy-related product as in claim 22 wherein taxonomically accurate color representations of the first and second species are generally complementary of each other such that coloration patterns of said first and second body parts are generally consistent with, and/or complementary of, each other.

32. A taxidermy-related product as in claim 22, at least one of said first and second body parts being comprised entirely of materials foreign to naturally-occurring members of the respective species.

33. A taxidermy-related product as in claim 22, said product comprising a visual appearance surface comprised of one or more layers, continuous portions of said one or more layers being comprised predominantly of synthetic plastics.

34. As an article of manufacture, a taxidermy-related product comprising:
(a) in three-dimensional representation, a generally taxonomically accurate, optionally scaled, first core body part of a first species of animals, the representation of said first core body part comprising a first interface locus; and
(b) in three-dimensional representation, a generally taxonomically accurate, optionally scaled, second body part of a second species of animals, different from the first species, the representation of said second body part comprising a second interface locus,
the first and second body parts being merged with each other so as to present a unitary product, one of said first and second species being a natural predator of the other of said first and second species.

35. A taxidermy-related product as in claim 34 wherein said first core body part, in the first species, includes an abdominal cavity.

36. A taxidermy-related product as in claim 35 wherein said second body part, in the second species, includes a head.

37. A taxidermy-related product as in claim 35 wherein said first species is an aquatic animal, selected from the group consisting of fish and amphibians, including alligators.

38. A taxidermy-related product as in claim 34 wherein said second species is an aquatic animal, selected from the group consisting of fish and amphibians, including alligators.

39. A taxidermy-related product as in claim 34 wherein said first species is a fish and said second species is an amphibian.

40. A taxidermy-related product as in claim 34 wherein said first species is an alligator and said second species is a fish.

41. A taxidermy-related product as in claim 34 wherein taxonomically accurate color representations of the first and second species are generally complementary of each other such that coloration patterns of said first and second body parts are generally consistent with, and/or complementary of, each other.

42. A taxidermy-related product as in claim 34, at least one of said first and second body parts being comprised entirely of materials foreign to naturally-occurring members of the respective species.

43. A taxidermy-related product as in claim 34, said product comprising a visual appearance surface comprised of one or more layers, continuous portions of said one or more layers being comprised predominantly of synthetic plastics.
